(19) United States
(12) Patent Application Publication
(10) Pub. No.: US 2018/0354653 A1
(43) Pub. Date: Dec. 13, 2018

(54) PROCESS FOR REPAIRING AN AIRCRAFT

(71) Applicant: Airbus Operations GmbH, Hamburg (DE)

(72) Inventors: Mika Sachse, Kakenstorf (DE); Juergen Neumann, Bremen (DE)

(21) Appl. No.: 16/002,542

(22) Filed: Jun. 7, 2018

Related U.S. Application Data
(60) Provisional application No. 62/516,522, filed on Jun. 7, 2017.

(51) Int. Cl. B64F 5/40; B64F 5/60; G07C 5/00; G07C 5/08; G06Q 10/08; G06Q 10/00

(52) U.S. Cl. CPC B64F 5/40; B64F 5/60; G07C 5/006; G06T 7/0004; G07C 5/0808; G06Q 10/0875; G06Q 10/20; G07C 5/085

(57) ABSTRACT

Processes for repairing an aircraft. The processes utilize a portable electronic device for entry of data associated with a defect including photographs of the defect. A particular repair process is selected based upon information associated with the defect, as well as information associated with materials needed for repairing the defect. A record of defects associated with a particular aircraft may be stored in a database. To repair the defect, the database may be accessed and a particular defect record may be selected. The particular repair process is displayed, allowing the defect to be repaired. The defect record may be stored after the particular defect is repaired to allow for access to data associated with same.

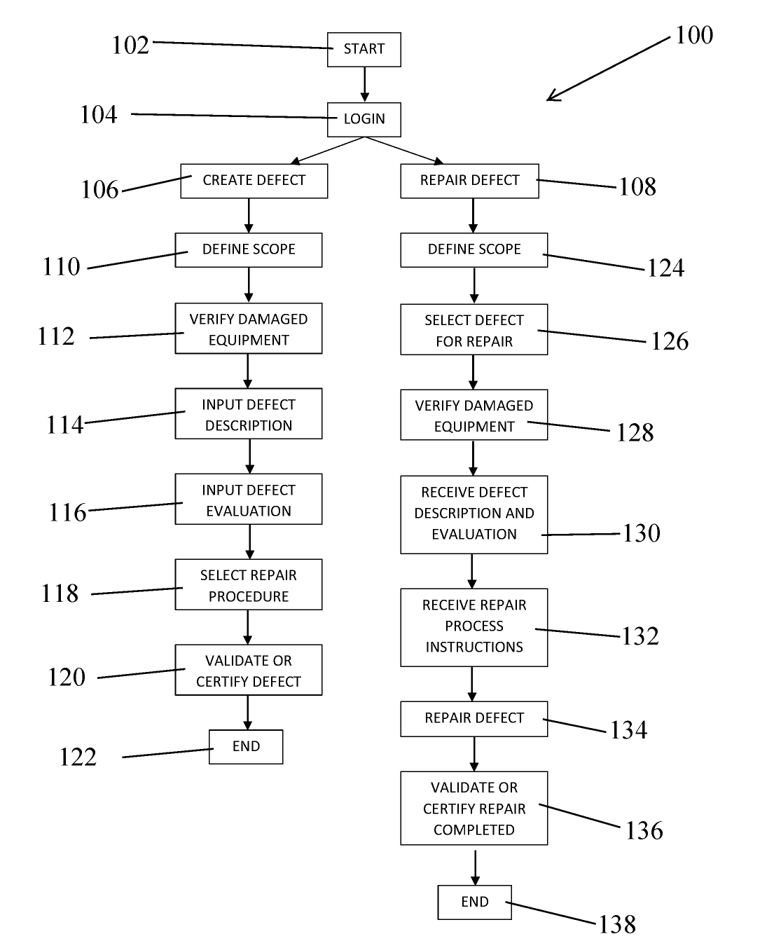

### RELATED APPLICATIONS

This application claims priority to U.S. Provisional Patent Application Ser. No. 62/516,522 filed on Jun. 7, 2017, the entirety of which is incorporated herein by reference.

### FIELD OF THE INVENTION

This invention relates generally to an aircraft, and more specifically to a process for repairing damage to the aircraft, for example, in an interior of the aircraft.

### BACKGROUND OF THE INVENTION

As a result of use, an aircraft often becomes damaged. For example, the interior of an aircraft may become damaged by various causes. Specifically, a lining of an aircraft interior may be damaged by items striking or otherwise contacting the aircraft interior. As a result of the strike or contact, the interior of the aircraft may become scratched, dented, or cracked.

Current processes for recording and repairing the damage or defect exist. However, many current processes often do not provide complete records associated with the damage at the time of the repair. The lack of basic information associated with the defect is believed to create problems and needlessly increase the time consuming investigations associated with repairing the defect.

Additionally, as materials for the aircraft become more complex in terms of variants, options, and materials, repairing the damage may also increase in complexity due to the needed support functions associated with repairing such materials.

Therefore, there is a need for an effective and efficient process for recording and repairing damage to an aircraft that does not suffer from one or more of these drawbacks.

### SUMMARY OF THE INVENTION

The present invention is directed at solving one or more of these problems by providing a process for recording and repairing damage to aircraft.

Generally, the processes of the present invention utilize portable electronic devices and allow entry of data associated with the defect including photographs of the defect. A particular repair process for the defect is selected based upon information associated with the defect, as well as information (e.g., inventory levels) associated with materials needed for repairing the defect. A record of defects associated with a particular aircraft may be stored in a database. To repair the defect, the database may be accessed, and a particular defect record may be selected. The particular repair process is displayed, allowing the defect to be repaired according to, for example, the manufacturer's repair instructions. The defect record may be stored even after the particular defect is repaired to allow for access to the data to evaluate the aircraft, repair processes, individuals work history, equipment history and longevity, repair longevity, and other relevant issues that may be analyzed.

Accordingly, in one aspect the present invention may be characterized broadly as providing a process for repairing a defect in an aircraft by creating a defect record and repairing the defect. The defect record may be created by: identifying a defect in a piece of equipment; obtaining information relating to the piece of equipment; inputting a defect description and a defect severity to the defect record; and, selecting a repair procedure for the defect in the piece of equipment based, in part, upon inventory levels of repair materials. The defect may be repaired by: accessing the defect record, wherein the defect record includes the defect description, the defect severity, and the selected repair procedure; and, repairing the defect according to the selected repair procedure.

The process may also include maintaining the defect record in a database of defect records for the aircraft.

The process may further include that the defect record is created in a location that is different from a location where the defect is repaired.

The inputting the defect description may comprise obtaining at least one image of the defect with a camera and associating the at least one image with the defect record. It is contemplated that accessing the defect record comprises obtaining the at least one image of the defect.

The repairing the defect may also comprise receiving instructions for the selected repair procedure.

The obtaining information relating to the piece of equipment may further comprise scanning a QR-Code for the piece of equipment and receiving information regarding the piece of equipment. It is contemplated that the information regarding the piece of equipment may comprise an image of the piece of equipment. The inputting the defect description and the defect severity may comprise indicating a location of the defect on the piece of equipment by including an indication on the image of the piece of the equipment.

Accordingly, in another aspect of the present invention, the present invention may be generally characterized as providing a process for repairing a defect in an aircraft by creating a defect record and repairing the defect. The defect record may be created by: identifying a defect in a piece of equipment; obtaining information relating to the piece of equipment by scanning a QR-Code for the piece of equipment; inputting a defect description and a defect severity to the defect record; receiving information regarding inventory levels of repair materials for the piece of equipment; and, selecting a repair procedure for the defect in the piece of equipment based, in part, upon the inventory levels of repair materials. Further, the defect may be repaired by: accessing the defect record, wherein the defect record includes the defect description, the defect severity, and the selected repair procedure; receiving instructions for the selected repair procedure; and, repairing the defect according to the selected repair procedure.

The information regarding the piece of equipment that is obtained may comprise an image of the piece of equipment.

The inputting the defect description and the defect severity may comprise indicating a location of the defect on the piece of equipment by including an indication on an image of the piece of the equipment. It is contemplated that the image is obtained with a camera. It is also contemplated that the image is part of the information obtained by scanning a QR-Code for the piece of equipment. The accessing the defect record may comprise receiving the image and the indication on the image.

In yet another aspect of the present invention, the present invention may be characterized as providing a process for repairing a defect in an aircraft by creating a defect record and repairing the defect. The defect record may be created by: identifying a defect in a piece of equipment; obtaining information relating to the piece of equipment; inputting a defect description and a defect severity to the defect record; indicating a location of the defect on the piece of equipment by including an indication on an image of the piece of the equipment; receiving information regarding inventory levels of repair materials for the piece of equipment; and, selecting a repair procedure for the defect in the piece of equipment based, in part, upon the inventory levels of repair materials. The defect may be repaired by: accessing the defect record, wherein the defect record includes the defect description, the defect severity, the image of the piece of the equipment which includes the location of the defect, and the selected repair procedure; receiving instructions for the selected repair procedure; and, repairing the defect according to the selected repair procedure.

The image of the piece of the equipment may be from the information relating to the piece of equipment that is obtained.

The process may further include taking a photograph of the defect wherein the photograph is the image of the piece of the equipment which on which the location of the defect is indicated.

These processes, described in more detail below and in the attached drawings, provides numerous advantageous over current processes, including, for example, clearer and more definite identification of defects and material of the aircraft with same, reduction of incorrect repair procedures, and better and more complete record of damages/defects and repairs associated with same, to name a few. These and other benefits will be appreciated by those of skill in art in view of the present disclosure.

### DETAILED DESCRIPTION OF THE DRAWINGS

One or more exemplary embodiments of the present invention will be described below in conjunction with the following drawing FIGURE, in which:

the FIGURE shows a flow chart for a process according to one or more embodiments of the present invention.

### DETAILED DESCRIPTION OF THE INVENTION

With these above general aspects of the present invention in mind, one or more embodiments of the present invention will be described with the understanding that the following description is not intended to be limiting.

An exemplary process 100 according to the present invention is shown in the FIGURE and will be discussed below. It should be understood and appreciated that while the exemplary process 100 is discussed in terms of repairing an aircraft interior, the present invention is not intended to be limited and can be used for identifying and repairing defects in any portion of the aircraft.

The steps of the present process 100 are carried out, in part, with one or more portable or handheld electronic devices. The portable electronic devices can include a processor, memory, a display screen, and hardware (e.g., ports, interfaces, antennas, amplifiers, signal processors, etc.) for wired or wireless communication. The portable electronic devices may include software stored in a non-transitory medium, hardware, firmware, etc., containing executable instructions for causing the portable electronic devices to perform one or more steps of example methods. Example software can include an operating system running one or more applications (apps) that perform one or more steps of example methods and display data or information as well as allowing a user to enter data or information. The portable electronic devices also include a touch screen or other device or user interface for allowing a user to enter data or information. Additionally, the portable electronic device preferably also includes a camera or other image capturing device.

Preferably, the process 100 is implemented on an electronic device through an app or through software that may be externally hosted. Additionally, the app or software obtains data or information about the particular aircraft, the inventory levels of repair materials, repair processes, the piece of equipment that is damaged, and other data or information from one or more databases. The databases can be located within the software or app, or, alternatively, it may be stored on a server and accessed remotely.

In the FIGURE, the process 100 begins at the start 102. This can include powering on the portable electronic devices or waking the portable electronic devices from a sleep mode.

In the next step of the process 100, a login step 104 may be completed by an operator or user. Preferably, the portable electronic device displays two options upon successful login, create defect 106 and repair defect 108. The use of the login step 104 can ensure that only appropriate individuals have the ability to create defects and that only appropriate individuals have the ability to indicate that a repair of a defect has been completed. Thus, each user may have different rights or permissions.

As discussed above, the process 100 is directed to creating a defect record for the identified defect, and then utilizing the defect record for repairing the defect. Typically, these steps 106, 108 are performed by two different individuals, or users, that may be located in different geographical locations. Thus, creating a clear and precise record of the defect allows the individual repairing the defect to do so in a timely and efficient manner, and provides precise information and a record of the defect and repair. The defect records are preferably electronically stored records to minimize the creation and retention of paper records.

Accordingly, on selecting create defect 108, the process 100 proceeds along the left branch of the process 100 as shown in the FIGURE. Thus, the next step is define scope 110 in which the user enters data or information to indicate, for example, a type of aircraft, an airline, and identification number associated with the particular aircraft. This step 110 correlates the defect record with the particular aircraft.

Subsequently the process 100 includes a step of verify damaged equipment 112, the defect record is associated with the damaged equipment and information associated with the piece of equipment is obtained. Preferably, the portable electronic device includes a camera allowing the user to scan a QR-Code to identify the damaged equipment, as well as obtain the information related to that piece of equipment (including, for example, any prior repairs that have been completed). The use of the QR-Code is merely exemplary and other similar devices can be used, such as RFID or other, that allow the portable electronic device to obtain data or information about the piece of equipment. The QR-Code can be physically attached to the piece of equipment or it may be, for example, in a compilation of QR-Codes for that aircraft.

In the next step, the process 100 includes input defect description 114. This step 114 may include displaying, on the screen, information associated with the aircraft and the particular defect. This information is preferably accessed from one or more databases which may be local or remote, as mentioned above. Additionally, this step 114 includes entry of a description of the defect, including a location of the defect to be repaired.

Specifically, the location of the defect is indicated on one of more images of the piece of equipment. For example, the step of verify damaged equipment 112 may include receiving one or more images of the piece of equipment. The images may be photographs, design drawings, renderings, or computer generated images. The user may indicate on the image where the damage is located on the piece of equipment. Additionally, the input defect description step 114 may include taking photographs of the piece of equipment, including photographs of the defect. These photographs may also be the image on which the location of the defect is indicated. The images with the location, as well as any photographs taken, are associated with the defect record.

After completion of the input defect description step 114, the process 100 proceeds to an input defect evaluation step 116. In this step 116, data associated with the severity of the defect is entered into the defect record. This severity data may include information about the size of the defect. Additionally, the device may provide preset descriptors of various levels of severity and allow the user to select one of the preset descriptors. For example, the device can display options such as “Damage that does not go through panel,” “Damage that goes through panel,” and “Damage to the edge.” The user will evaluate the defect and select the appropriate severity level to enter it.

After the defect description step 114, the process 100 proceeds to a step of select repair procedure 118, in which the user selects the appropriate repair procedure to be used for the defect. In addition to the information about the defect, the app or software preferably has access to inventory levels of materials required for repairing various surfaces and equipment located in the aircraft. Based upon the inventory levels of particular repair materials, and the information about the defect, the app or software may display one or more repair options that are available. The selected repair procedure is associated with the defect record.

Upon selecting a repair procedure, a final step of validate or certify defect 120 results in the completion of creating the defect record. The completed defect record may be transmitted to a database via a wireless transmission (for example by WiFi, 3G or 4G link) or a wired transmission (for example, using an Ethernet RJ45 cable or an USB cable). Accordingly, the first portion of the process 100 is completed and, thus, the create defect 106 portion of the process 100 ends, as depicted, in step 122; however, the user can continue to enter additional defects and create additional defect records.

Once the creation of the defect record has been completed, the repairing portion of the process 100 may also begin with the start step 102 discussed above. Furthermore, the repairing portion of the process 100 may also include the login step 104, after which, for the repair portion of the process 100, repair defect 108 is selected. This results in the process 100 following the steps on the right side of the FIGURE.

Specifically, the repair portion of the process 100 also includes a define scope step 124 in which a type of aircraft is selected or entered, along with information associated with an airline and/or an aircraft identification number.

In response to the information or data entered or selected, the app or software accesses the database of defect records associated with the particular aircraft and displays those defect records. For example, the app or software, may display an image of the aircraft with a summary or overview of defects records based upon various sections or portions of the aircraft. In addition, information associated with the severity of the individual defects can be shown based upon colors or other indicators.

For example, upon selection of a particular section of the aircraft, the app or software displays a list of defect records associated with the selected section of the aircraft. The next step of the process 100 is select defect for repair 126 in which the user selects the defect for the desired repair.

Once the desired defect is selected for repair, the process 100 proceeds to a step of verifying damaged equipment 128 which utilizes the QR-Code (or other similar devices such as RFID) again to obtain information associated with the equipment/materials associated with the defect and defect record. As indicated above, this information can be stored locally or accessed from an external database.

As shown in step 130, the app or software receives and displays the defect record, including information associated with the defect (and piece of equipment), the description of the defect, the severity of the defect, images with the location of the defect, and photographs.

Additionally, as shown in step 132, the process includes receiving the particular instructions for repairing the defect and displaying these instructions—allowing the defect to be repaired, in step 134, according to the previously selected repair procedure (from step 118). Again, the details of the repair procedures can be stored locally or accessed via an external database.

Once the defect has been repaired, the process 100 includes a step of validate or certify repair completed 136, in which a user verifies that the repair is completed and the defect record may be indicated as completed, and the process 100 ends in step 138. However, the defect record may be stored in a database allowing for access at a later time.

There are various advantages of such a process 100 for both an aircraft operator and an aircraft manufacturer and repairer. For example, such a process 100 is believed to provide for clear and secured identification of the defective piece of equipment (e.g., laminate, smc, sandwich, rapid decompression concept, collapsing lining concept, cargo door lining, etc.).

Additionally, such a process 100 is believed to at least reduce the possibility of an incorrect repair procedure from being performed by providing the appropriate or best repair procedure. Further, the repair process may be selected to be the fastest depending on inventories of materials.

Moreover, such a process 100 may improve the processing of repair requests, as well as maintain the records of the repairs to manage faulty equipment.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A process for repairing a defect in an aircraft, the process comprising:
creating a defect record by:
identifying a defect in a piece of equipment;
obtaining information relating to the piece of equipment;
inputting a defect description and a defect severity to the defect record; and,
selecting a repair procedure for the defect in the piece of equipment based, in part, upon inventory levels of repair materials; and,
repairing the defect by:
accessing the defect record, wherein the defect record includes the defect description, the defect severity, and the selected repair procedure; and,
repairing the defect according to the selected repair procedure from the defect record.

2. The process of claim 1 further comprising:
maintaining the defect record in a database of defect records for the aircraft.

3. The process of claim 1, wherein the defect record is created in a location that is different from a location where the defect is repaired.

4. The process of claim 1, wherein inputting the defect description comprises obtaining at least one image of the defect with a camera and associating the at least one image with the defect record.

5. The process of claim 4, wherein accessing the defect record comprises obtaining the at least one image of the defect.

6. The process of claim 1, wherein repairing the defect further comprises receiving instructions for the selected repair procedure.

7. The process of claim 1, wherein obtaining information relating to the piece of equipment comprises scanning a QR-Code for the piece of equipment and receiving information regarding the piece of equipment.

8. The process of claim 7, wherein the information regarding the piece of equipment received comprises an image of the piece of equipment.

9. The process of claim 8, wherein inputting the defect description and the defect severity comprises indicating a location of the defect on the piece of equipment by including an indication on the image of the piece of the equipment.

10. A process for repairing a defect in an aircraft comprising:
creating a defect record by:
identifying a defect in a piece of equipment;
obtaining information relating to the piece of equipment by scanning a QR-Code for the piece of equipment;
inputting a defect description and a defect severity to the defect record;
receiving information regarding inventory levels of repair materials for the piece of equipment; and,
selecting a repair procedure for the defect in the piece of equipment based, in part, upon the inventory levels of repair materials; and,
repairing the defect by:
accessing the defect record, wherein the defect record includes the defect description, the defect severity, and the selected repair procedure;
receiving instructions for the selected repair procedure; and,
repairing the defect according to the selected repair procedure from the defect record.

11. The process of claim 10, wherein the information regarding the piece of equipment received comprises an image of the piece of equipment.

12. The process of claim 10, wherein inputting the defect description and the defect severity comprises indicating a location of the defect on the piece of equipment by including an indication on an image of the piece of equipment.

13. The process of claim 12, wherein the image is obtained with a camera.

14. The process of claim 12, wherein the information obtained by scanning a QR-Code for the piece of equipment comprises the image of the piece of equipment.

15. The process of claim 12, wherein accessing the defect record includes receiving the image and the location of the defect on the image.

16. A process for repairing a defect in an aircraft comprising:
creating a defect record by:
identifying a defect in a piece of equipment;
obtaining information relating to the piece of equipment;
inputting a defect description and a defect severity to the defect record;
indicating a location of the defect on the piece of equipment by including an indication on an image of the piece of the equipment;
receiving information regarding inventory levels of repair materials for the piece of equipment; and,
selecting a repair procedure for the defect in the piece of equipment based, in part, upon the inventory levels of repair materials; and,
repairing the defect by:
accessing the defect record, wherein the defect record includes the defect description, the defect severity, the image of the piece of the equipment which includes the location of the defect, and the selected repair procedure;
receiving instructions for the selected repair procedure; and,
repairing the defect according to the selected repair procedure from the defect record.

17. The process of claim 16, wherein the information relating to the piece of equipment that is obtained comprises the image of the piece of the equipment.

18. The process of claim 16, further comprising:
taking a photograph of the defect wherein the photograph is the image of the piece of the equipment which on which the location of the defect is indicated.
